(19) United States
(12) Patent Application Publication
(10) Pub. No.: US 2025/0239388 A1
(43) Pub. Date: Jul. 24, 2025

(54) MULTILAYER COIL COMPONENT

(71) Applicant: Murata Manufacturing Co., Ltd., Kyoto-fu (JP)

(72) Inventors: Yutaka NOGUCHI, Nagaokakyo-shi (JP); Yoshiko BANNO, Nagaokakyo-shi (JP); Kouhei OSAKI, Nagaokakyo-shi (JP); Yasushi YUNOKI, Nagaokakyo-shi (JP)

(73) Assignee: Murata Manufacturing Co., Ltd., Kyoto-fu (JP)

(21) Appl. No.: 19/008,222

(22) Filed: Jan. 2, 2025

(30) Foreign Application Priority Data
Jan. 19, 2024 (JP) 2024-006804

(51) Int. Cl. H01F 5/04; H01F 5/06; H01F 27/28

(52) U.S. Cl. CPC H01F 5/04; H01F 5/06; H01F 27/2852

(57) ABSTRACT

A multilayer coil component includes an element body including stacked magnetic layers composed of metal magnetic particles, a first coil inside the element body, including a first conductor layer, and having first and second ends, a second coil inside the element body, including a second conductor layer having third and fourth ends, and located further on a bottom surface side of the element body than is the first coil in a stacking direction of the magnetic layers, a first outer electrode on a bottom surface of the element body and connected to the first end of the first coil, a second outer electrode on the bottom surface and connected to the second end of the first coil, a third outer electrode on the bottom surface and connected to the third end of the second coil, a fourth outer electrode on the bottom surface.

### CROSS-REFERENCE TO RELATED APPLICATION

This application claims benefit of priority to Japanese Patent Application No. 2024-006804, filed Jan. 19, 2024, the entire content of which is incorporated herein by reference.

### BACKGROUND

### Technical Field

The present disclosure relates to a multilayer coil component.

### Background Art

Japanese Unexamined Patent Application Publication No. 2023-109293 discloses a coil component including a magnetic support layer having a first main surface and a second main surface located on a side opposite to the first main surface side, a first coil pattern disposed on the first main surface of the magnetic support layer, a second coil pattern disposed on the second main surface of the magnetic support layer, a first magnetic resin layer that is provided on the first main surface of the magnetic support layer and in which the first coil pattern is embedded, and a second magnetic resin layer that is provided on the second main surface of the magnetic support layer and in which the second coil pattern is embedded. The coil component further includes first and second terminal electrodes exposed from the first magnetic resin layer and connected to one end and another end of the first coil pattern, respectively, and third and fourth terminal electrodes exposed from the second magnetic resin layer and connected to one end and another end of the second coil pattern, respectively, in which the magnetic support layer has higher magnetic permeability than that of the first and second magnetic resin layers.

### SUMMARY

According to Japanese Unexamined Patent Application Publication No. 2023-109293, since the first coil pattern and the second coil pattern are disposed on the front and back sides of the magnetic support layer, the chip size can be reduced. Moreover, in Japanese Unexamined Patent Application Publication No. 2023-109293, embodiments in which the number of turns of each of the first coil pattern and the second coil pattern is approximately one are described.

However, an inductor capable of dealing with a large current with a low inductance and having a small mounting area is desired.

Accordingly, the present disclosure provides a multilayer coil component capable of dealing with a large current with a low inductance and having a small mounting area.

A multilayer coil component of the present disclosure includes an element body including a plurality of stacked magnetic layers composed of metal magnetic particles, a first coil disposed inside the element body, including a first conductor layer, and having a first end and a second end, a second coil disposed inside the element body, including a second conductor layer, having a third end and a fourth end, and located further on a bottom surface side of the element body than is the first coil in a stacking direction of the magnetic layers, a first outer electrode provided on a bottom surface of the element body and connected to the first end of the first coil, a second outer electrode provided on the bottom surface of the element body and connected to the second end of the first coil, a third outer electrode provided on the bottom surface of the element body and connected to the third end of the second coil, and a fourth outer electrode provided on the bottom surface of the element body and connected to the fourth end of the second coil. The multilayer coil component further comprises a first via conductor provided inside the element body and connecting the first end of the first coil and the first outer electrode, a second via conductor provided inside the element body and connecting the second end of the first coil and the second outer electrode, a third via conductor provided inside the element body and connecting the third end of the second coil and the third outer electrode, and a fourth via conductor provided inside the element body and connecting the fourth end of the second coil and the fourth outer electrode.

According to the present disclosure, a multilayer coil component capable of dealing with a large current with a low inductance and having a small mounting area can be provided.

### BRIEF DESCRIPTION OF THE DRAWINGS

FIG. 1 is a perspective view schematically illustrating an example of an inside structure of a multilayer coil component according to a first embodiment of the present disclosure;

FIG. 2 is a perspective view schematically illustrating an external appearance of the multilayer coil component illustrated in FIG. 1;

FIG. 3 is an exploded perspective view of the multilayer coil component illustrated in FIG. 1;

FIG. 4 is a perspective view schematically illustrating an example of an inside structure of a multilayer coil component according to a second embodiment of the present disclosure;

FIG. 5 is an exploded perspective view of the multilayer coil component illustrated in FIG. 4;

FIG. 6 is a perspective view schematically illustrating an example of an inside structure of a multilayer coil component according to a third embodiment of the present disclosure;

FIG. 7 is a perspective view schematically illustrating an example of an inside structure of a multilayer coil component according to a fourth embodiment of the present disclosure; and

FIG. 8 is a perspective view schematically illustrating an example of an inside structure of a multilayer coil component according to a fifth embodiment of the present disclosure.

### DETAILED DESCRIPTION

Hereinafter, a multilayer coil component of the present disclosure will be described. However, the present disclosure is not limited to the following embodiments, and appropriate modifications can be made without departing from the scope and the spirit of the present disclosure. Combinations of two or more individual configurations preferred in the present disclosure described in the following embodiments are also included in the present disclosure.

The multilayer coil component of the present disclosure is used for, for example, a choke coil for a direct current-direct current (DC-DC) converter. The multilayer coil component of the present disclosure is applicable to a purpose other than a choke coil for a DC-DC converter.

The following embodiments are examples, and it is needless to say that partial replacements or combinations of configurations described in different embodiments can be made. In a second embodiment and subsequent embodiments, descriptions of matters which are common to those in a first embodiment are omitted, and only different points are described. In particular, the same advantages provided by the same configurations are not referred in each embodiment.

In the following description, when no particular distinction is to be made between the embodiments, each embodiment is simply referred to as a “multilayer coil component of the present disclosure”.

In the present specification, the terms indicating the relationship between elements (for example, the term “vertical”, “parallel”, “orthogonal”, or the like) and the terms indicating the shapes of the elements are not meant to represent only strict meanings, but are meant to include a substantially equal range, for example, a difference of approximately several percentages. In addition, in the present specification, the terms “same” and “equal” are not meant to refer to only a case of being completely equal, but are meant to include a case of being substantially equal, for example, a difference of approximately several percentages.

The drawings referenced in the following description are schematic views, and dimensions, aspect-ratio scales, or the like illustrated in the drawings are different from those of actual products in some cases. In the figures, the same reference numerals are used for the same or corresponding portions. In addition, in the individual figures, the same elements are denoted by the same reference numerals, and repetitive description will be omitted.

### First Embodiment

In a multilayer coil component according to the first embodiment of the present disclosure, a first coil and a second coil are disposed inside an element body.

FIG. 1 is a perspective view schematically illustrating an example of an inside structure of the multilayer coil component according to the first embodiment of the present disclosure. Note that the shapes, arrangements, or the like of the multilayer coil component and the respective constituents are not limited to those of the illustrated example.

The multilayer coil component 1 illustrated in FIG. 1 includes an element body 10, a first coil 21, a second coil 22, a first outer electrode 31, a second outer electrode 32, a third outer electrode 33, a fourth outer electrode 34, a first via conductor 41, a second via conductor 42, a third via conductor 43, and a fourth via conductor 44.

In FIG. 1, a length direction, a width direction, and a height direction of the multilayer coil component 1 and the element body 10 are indicated as an L direction, a W direction, and a T direction, respectively. The length direction L, the width direction W, and the height direction T are orthogonal to each other. A mounting surface of the multilayer coil component 1 is, for example, a surface (LW surface) parallel to the length direction L and the width direction W.

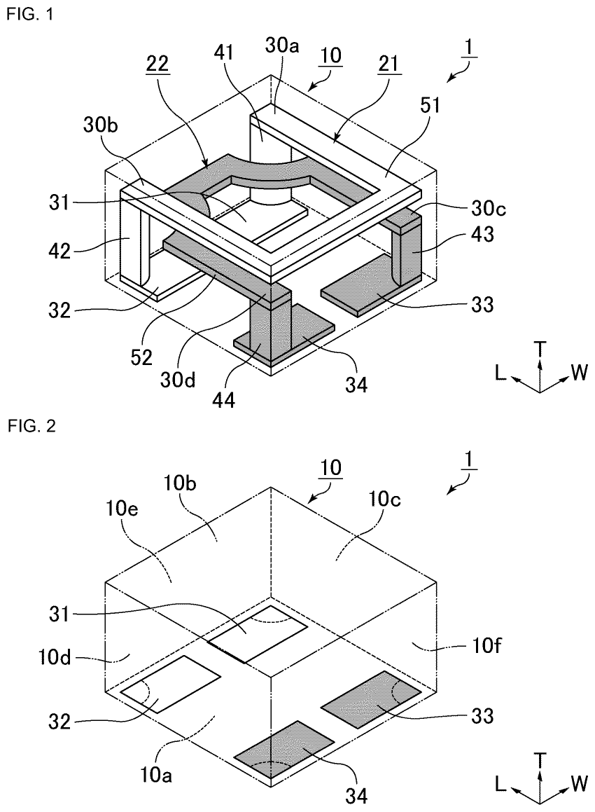

FIG. 2 is a perspective view schematically illustrating an external appearance of the multilayer coil component illustrated in FIG. 1.

The element body 10 has, for example, a perpendicular parallelepiped shape or a substantially perpendicular parallelepiped shape having six surfaces. Corner portions and ridge portions of the element body 10 may be rounded. Each corner portion is a portion where three surfaces of the element body 10 intersect, and each ridge portion is a portion where two surfaces of the element body 10 intersect.

As illustrated in FIG. 2, the element body 10 has, for example, a first main surface 10a and a second main surface 10b opposite to each other in the height direction T, a first side surface 10c and a second side surface 10d opposite to each other in the length direction L orthogonal to the height direction T, and a third side surface 10e and a fourth side surface 10f opposite to each other in the width direction W orthogonal to the length direction L and the height direction T. In the example illustrated in FIG. 2, the first main surface 10a of the element body 10 corresponds to a bottom surface of the element body 10.

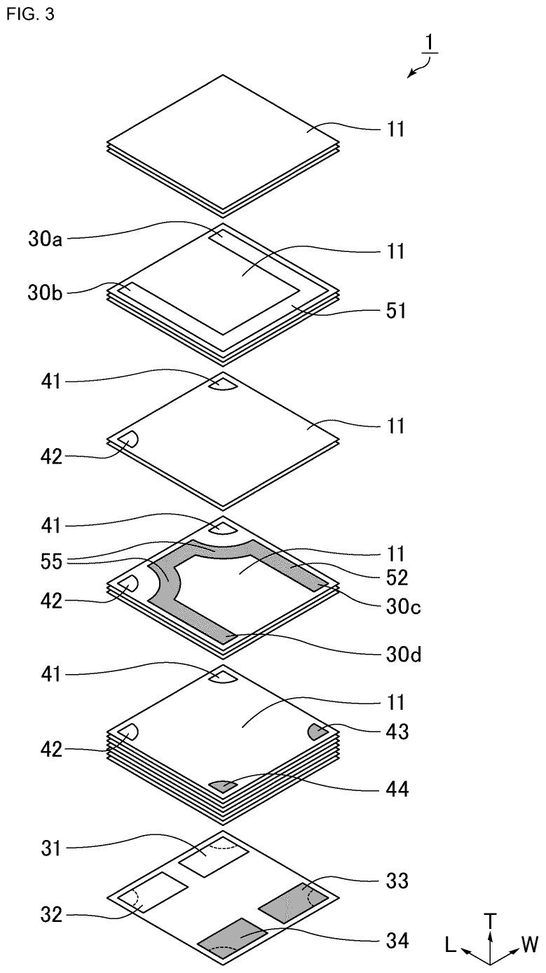

FIG. 3 is an exploded perspective view of the multilayer coil component illustrated in FIG. 1.

The element body 10 includes a plurality of stacked magnetic layers 11. In the example illustrated in FIG. 3, a stacking direction of the magnetic layers 11 is the height direction T. Note that in the multilayer coil component 1, boundaries between the respective magnetic layers 11 included in the element body 10 do not have to clearly appear.

When the element body 10 has a stacked structure of the magnetic layers 11, the degree of freedom in designing the multilayer coil component 1 is increased. For example, when the multilayer coil component 1 including the first outer electrode 31, the second outer electrode 32, the third outer electrode 33, and the fourth outer electrode 34 on the bottom surface (the first main surface 10a) of the element body 10 is manufactured, the first coil 21 and the second coil 22 are easily extended to the bottom surface side.

The magnetic layers 11 are composed of metal magnetic particles. Examples of the metal magnetic particles include Fe, Co, Ni, or an alloy containing at least one kind of Fe, Co, and Ni. The metal magnetic particles are preferably Fe particles or Fe alloy particles. An Fe alloy is preferably an Fe—Si based alloy, an Fe—Si—Cr based alloy, an Fe—Si—Al based alloy, an Fe—Si—B—P—Cu—C based alloy, an Fe—Si—B—Nb—Cu based alloy, or the like.

A surface of each metal magnetic particle is preferably covered with an insulating film. When the surface of the metal magnetic particle is covered with an insulating film, the insulating properties between the metal magnetic particles can be increased. As a method for forming the insulating film on a surface of each metal magnetic particle, a sol-gel method, a mechanochemical method, or the like can be used. The material constituting the insulating film is preferably an oxide such as P and Si. In addition, the insulating film may be an oxide film formed through oxidizing of the surface of the metal magnetic particle. The thickness of the insulating film is preferably equal to or more than 1 nm and equal to or less than 50 nm (i.e., from 1 nm to 50 nm), more preferably equal to or more than 1 nm and equal to or less than 30 nm (i.e., from 1 nm to 30 nm), and still more preferably equal to or more than 1 nm and equal to or less than 20 nm (i.e., from 1 nm to 20 nm). For example, an image of a cross section obtained through polishing of a sample of the multilayer coil component is shot by a scanning electron microscope (SEM), and from the obtained SEM image, the thickness of the insulating film covering the surface of the metal magnetic particle can be measured.

An average particle diameter of the metal magnetic particles in the magnetic layers 11 is preferably equal to or more than 1 μm and equal to or less than 30 μm (i.e., from 1 μm to 30 μm), more preferably equal to or more than 1 μm and equal to or less than 20 μm (i.e., from 1 μm to 20 μm), and still more preferably equal to or more than 1 μm and equal to or less than 10 μm (i.e., from 1 μm to 10 μm). The average particle diameter of the metal magnetic particles in the magnetic layers 11 can be measured by the procedures described below. Images of the cross section obtained through cutting of a sample of the multilayer coil component are shot by an SEM in a region (for example, 130 μm×100 μm) of a plurality of portions (for example, five portions), the obtained SEM images are analyzed using image analysis software (for example, WinROOF 2018 (manufactured by Mitani Corporation), and equivalent circle diameters of the metal magnetic particles are obtained. An average value of the obtained equivalent circle diameters is the average particle diameter of the metal magnetic particles.

As illustrated in FIG. 1, the first coil 21 and the second coil 22 are disposed inside the element body 10. The first coil 21 and the second coil 22 are preferably magnetically coupled.

The first coil 21 includes a first conductor layer 51 and has a first end 30a and a second end 30b.

The number of turns of the first coil 21 is preferably less than one. The first coil 21 preferably includes one conductor layer.

The second coil 22 is located further on the bottom surface side (the first main surface 10a side) of the element body 10 than is the first coil 21 in the stacking direction (for example, the height direction T) of the magnetic layers 11.

The second coil 22 includes a second conductor layer 52 and has a third end 30c and a fourth end 30d. The thickness of the second conductor layer 52 is preferably the same as the thickness of the first conductor layer 51.

The number of turns of the second coil 22 is preferably less than one. The second coil 22 preferably includes one conductor layer. The number of turns of the second coil 22 may be the same as or may be different from the number of turns of the first coil 21.

In plan view in the stacking direction (for example, the height direction T), the first coil 21 has a square U shape having three sides.

In plan view in the stacking direction (for example, the height direction T), the second coil 22 has a square U shape having three sides and two chamfered corner portions. Note that the middle side of the three sides may disappear by chambering.

Specifically, the second coil 22 preferably includes avoiding portions 55 (see FIG. 3) in corner portions. The avoiding portions 55 of the second coil 22 are preferably disposed inside the first via conductor 41 and inside the second via conductor 42 in plan view in the stacking direction (for example, the height direction T) so as to avoid the first via conductor 41 and the second via conductor 42. The shape of each of the avoiding portions 55 is not particularly limited, and may be linear or curved. In addition, the avoiding portion 55 may be composed of two or more lines.

The first outer electrode 31 and the second outer electrode 32 are provided on the bottom surface (the first main surface 10a) of the element body 10 and are electrically coupled to the first coil 21. Specifically, the first outer electrode 31 is connected to the first end 30a of the first coil 21, and the second outer electrode 32 is connected to the second end 30b of the first coil 21.

The third outer electrode 33 and the fourth outer electrode 34 are provided on the bottom surface (the first main surface 10a) of the element body 10 and are electrically coupled to the second coil 22. Specifically, the third outer electrode 33 is connected to the third end 30c of the second coil 22, and the fourth outer electrode 34 is connected to the fourth end 30d of the second coil 22.

The first outer electrode 31 and the second outer electrode 32, and the third outer electrode 33 and the fourth outer electrode 34 are disposed at positions where the first outer electrode 31 and the second outer electrode 32, and the third outer electrode 33 and the fourth outer electrode 34 face each other, respectively, and a straight line connecting the first outer electrode 31 to the third outer electrode 33 and a straight line connecting the second outer electrode 32 to the fourth outer electrode 34 preferably do not intersect with each other.

The first outer electrode 31 may be provided only on the first main surface 10a of the element body 10, but the first outer electrode 31 may be provided so as to extend over the first main surface 10a of the element body 10 and at least one of the first side surface 10c and the third side surface 10e.

The second outer electrode 32 may be provided only on the first main surface 10a of the element body 10, but the second outer electrode 32 may be provided so as to extend over the first main surface 10a of the element body 10 and at least one of the second side surface 10d and the third side surface 10e.

The third outer electrode 33 may be provided only on the first main surface 10a of the element body 10, but the third outer electrode 33 may be provided so as to extend over the first main surface 10a of the element body 10 and at least one of the first side surface 10c and the fourth side surface 10f.

The fourth outer electrode 34 may be provided only on the first main surface 10a of the element body 10, but the fourth outer electrode 34 may be provided so as to extend over the first main surface 10a of the element body 10 and at least one of the second side surface 10d and the fourth side surface 10f.

Each of the first outer electrode 31, the second outer electrode 32, the third outer electrode 33, and the fourth outer electrode 34 may be composed of a conductive material such as Ag. For example, each of the first outer electrode 31, the second outer electrode 32, the third outer electrode 33, and the fourth outer electrode 34 includes a base electrode layer containing Ag and at least one plating layer provided above the base electrode layer. It is preferable that the plating layer includes a Cu plating layer provided above the base electrode layer, or includes an Ni plating layer provided above the base electrode layer and further includes an Sn plating layer provided above the Ni plating layer.

The thickness of each of the first outer electrode 31, the second outer electrode 32, the third outer electrode 33, and the fourth outer electrode 34 is preferably equal to or more than 5 μm and equal to or less than 100 μm (i.e., from 5 μm to 100 μm) and more preferably equal to or more than 10 μm and equal to or less than 50 μm (i.e., from 10 μm to 50 μm). The thicknesses of the first outer electrode 31, the second outer electrode 32, the third outer electrode 33, and the fourth outer electrode 34 are preferably the same.

The thickness of an outer electrode such as the first outer electrode 31 and the like can be measured by the procedures described below. A sample is polished by the same method as the above-described method, and an image of a portion of the outer electrode is shot by an SEM. In the obtained SEM image, one portion of an approximately central portion of the outer electrode is measured and is defined as the thickness of the outer electrode.

The first via conductor 41, the second via conductor 42, the third via conductor 43, and the fourth via conductor 44 are provided inside the element body 10.

The first via conductor 41 connects the first end 30a of the first coil 21 and the first outer electrode 31. The first via conductor 41 preferably extends in the stacking direction (for example, the height direction T). The first via conductor 41 may have a stacked structure.

The second via conductor 42 connects the second end 30b of the first coil 21 and the second outer electrode 32. The second via conductor 42 preferably extends in the stacking direction (for example, the height direction T). The second via conductor 42 may have a stacked structure.

The third via conductor 43 connects the third end 30c of the second coil 22 and the third outer electrode 33. The third via conductor 43 preferably extends in the stacking direction (for example, the height direction T). The third via conductor 43 may have a stacked structure.

The fourth via conductor 44 connects the fourth end 30d of the second coil 22 and the fourth outer electrode 34. The fourth via conductor 44 preferably extends in the stacking direction (for example, the height direction T). The fourth via conductor 44 may have a stacked structure.

In the multilayer coil component 1, the bottom surface (the first main surface 10a) of the element body 10 can serve as a mounting surface. That is, since the multilayer coil component 1 can be mounted using the bottom surface, the mounting area can be made small.

In the multilayer coil component 1, each of the first outer electrode 31, the second outer electrode 32, the third outer electrode 33, the fourth outer electrode 34, the first via conductor 41, the second via conductor 42, the third via conductor 43, the fourth via conductor 44, the first conductor layer 51, and the second conductor layer 52 may be formed through forming of substantially the same conductor pattern by printing a plurality of times.

The shape, vertical to the stacking direction, of each of the first via conductor 41, the second via conductor 42, the third via conductor 43, and the fourth via conductor 44 is not particularly limited, and examples of the shape include a polygonal shape such as a rectangle, a circle, an ellipse, and a fan shape. In the example illustrated in FIG. 3, the shape, vertical to the stacking direction, of each of the first via conductor 41, the second via conductor 42, the third via conductor 43, and the fourth via conductor 44 is a fan shape. Among these via conductors, the first via conductor 41 and the second via conductor 42 located at corner sections of the magnetic layers 11 constituting the element body 10 each have a fan shape, as a result of which the avoiding portions 55 can be made small, and the inner diameter of the second coil 22 can be made large. On the other hand, the third via conductor 43 and the fourth via conductor 44 may have a fan shape or may have a shape other than a fan shape.

Each of the first outer electrode 31, the second outer electrode 32, the third outer electrode 33, and the fourth outer electrode 34 preferably has an area, viewed in the stacking direction, larger than that of each of the first via conductor 41, the second via conductor 42, the third via conductor 43, and the fourth via conductor 44 so as to have the same shape.

Among the first via conductor 41, the second via conductor 42, the third via conductor 43, and the fourth via conductor 44, at least the third via conductor 43 and the fourth via conductor 44 are preferably not exposed on a side surface of the element body 10. On the other hand, the first via conductor 41 and the second via conductor 42 do not have to be exposed on a side surface of the element body 10 or may be exposed on at least one side surface of the element body 10. When the first via conductor 41 and the second via conductor 42 are exposed, the avoiding portions 55 can be made small, and the inner diameter of the second coil 22 can be made large.

### Second Embodiment

In a multilayer coil component according to the second embodiment of the present disclosure, a distance between the third via conductor and the fourth via conductor is shorter than a distance between the first via conductor and the second via conductor.

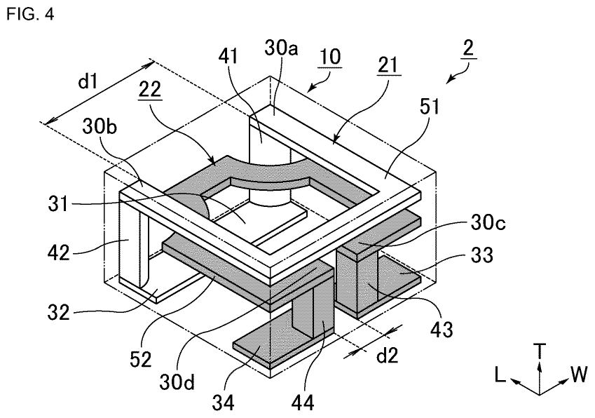

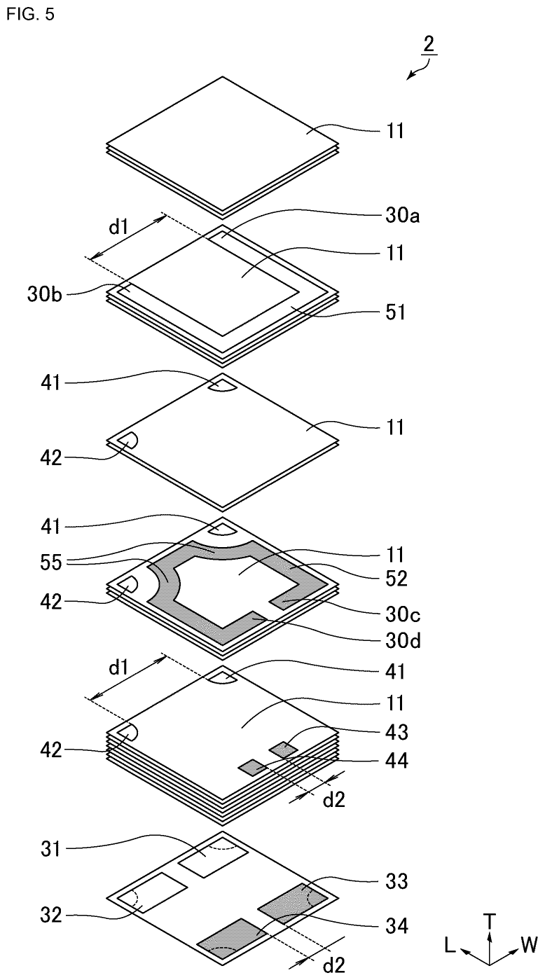

FIG. 4 is a perspective view schematically illustrating an example of an inside structure of the multilayer coil component according to the second embodiment of the present disclosure. FIG. 5 is an exploded perspective view of the multilayer coil component illustrated in FIG. 4.

In a multilayer coil component 2 illustrated in FIGS. 4 and 5, a distance (a length represented by d2 in FIGS. 4 and 5) between the third via conductor 43 and the fourth via conductor 44 is shorter than a distance (a length represented by d1 in FIGS. 4 and 5) between the first via conductor 41 and the second via conductor 42.

Since the first coil 21 is disposed further away from the bottom surface (the first main surface 10a) of the element body 10 than is the second coil 22, the first via conductor 41 and the second via conductor 42 are longer than the third via conductor 43 and the fourth via conductor 44. Therefore, even if the first conductor layer 51 and the second conductor layer 52 have the same shape, an inductance value of the first coil 21 having a longer via conductor becomes larger than an inductance value of the second coil 22 having a shorter via conductor. In addition, since the second coil 22 has the avoiding portions 55, an inner circumferential area of the coil becomes small, and thus the inductance value becomes smaller than that of the first coil 21.

Therefore, since the distance d2 between the third via conductor 43 and the fourth via conductor 44 is made shorter than the distance d1 between the first via conductor 41 and the second via conductor 42, a winding angle of the second conductor layer 52 is made larger than that of the first conductor layer 51. As a result, the difference in inductance value between the first coil 21 and the second coil 22 can be made small.

Moreover, since the distance d2 between the third via conductor 43 and the fourth via conductor 44 is made shorter than the distance dl between the first via conductor 41 and the second via conductor 42, coupling between the first coil 21 and the second coil 22 can be increased.

The shape, vertical to the stacking direction, of each of the first via conductor 41, the second via conductor 42, the third via conductor 43, and the fourth via conductor 44 is not particularly limited, and examples of the shape include a polygonal shape such as a rectangle, a circle, an ellipse, and a fan shape. In the example illustrated in FIG. 5, the shape, vertical to the stacking direction, of each of the first via conductor 41 and the second via conductor 42 is a fan shape, and the shape, vertical to the stacking direction, of each of the third via conductor 43 and the fourth via conductor 44 is a rectangle such as a square. Similarly to FIG. 3, the first via conductor 41 and the second via conductor 42 located at corner sections of the magnetic layers 11 constituting the element body 10 each have a fan shape, as a result of which the avoiding portions 55 can be made small, and the inner diameter of the second coil 22 can be made large. On the other hand, the third via conductor 43 and the fourth via conductor 44 may have a fan shape or a shape other than a fan shape.

Each of the first outer electrode 31, the second outer electrode 32, the third outer electrode 33, and the fourth outer electrode 34 preferably has an area, viewed in the stacking direction, larger than that of each of the first via conductor 41, the second via conductor 42, the third via conductor 43, and the fourth via conductor 44 so as to have the same shape.

A distance between the first outer electrode 31 and the second outer electrode 32 is preferably the same in the multilayer coil component 1 and the multilayer coil component 2.

Similarly, a distance between the third outer electrode 33 and the fourth outer electrode 34 is preferably the same in the multilayer coil component 1 and the multilayer coil component 2. A minimum value of the distance d2 between the third via conductor 43 and the fourth via conductor 44 is preferably the same as the distance between the third outer electrode 33 and the fourth outer electrode 34.

Among the first via conductor 41, the second via conductor 42, the third via conductor 43, and the fourth via conductor 44, at least the third via conductor 43 and the fourth via conductor 44 are preferably not exposed on a side surface of the element body 10. On the other hand, the first via conductor 41 and the second via conductor 42 do not have to be exposed on a side surface of the element body 10 or may be exposed on at least one side surface of the element body 10.

### Third Embodiment

In a multilayer coil component according to a third embodiment of the present disclosure, the element body further includes, between a layer in which the first coil is disposed and a layer in which the second coil is disposed, an insulating portion composed of an insulating material having lower magnetic permeability than that of the metal magnetic particles constituting the magnetic layers.

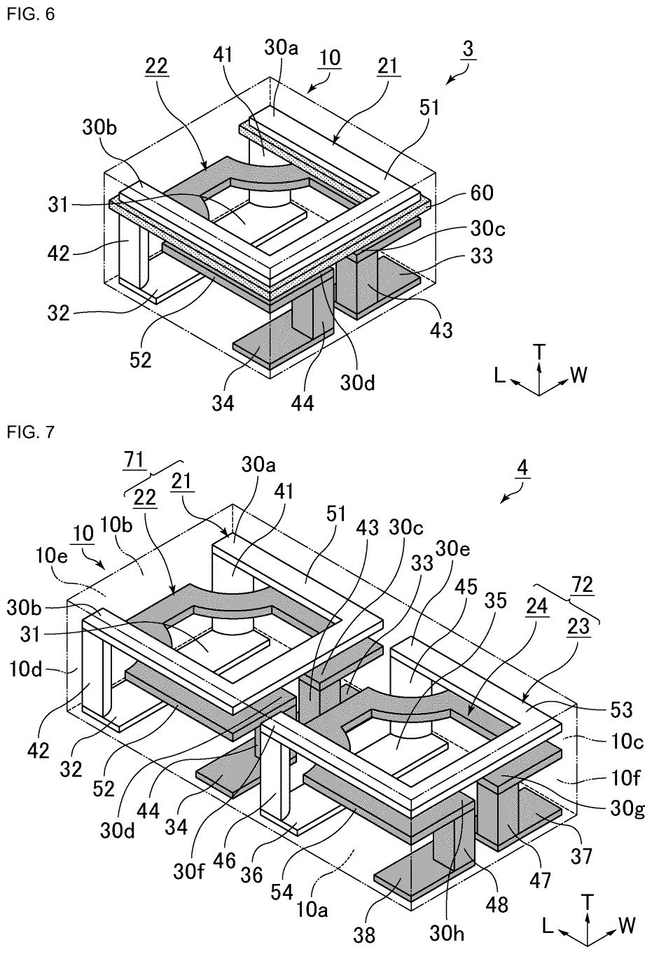

FIG. 6 is a perspective view schematically illustrating an example of an inside structure of the multilayer coil component according to the third embodiment of the present disclosure.

In a multilayer coil component 3 illustrated in FIG. 6, the element body 10 further includes, between the layer in which the first coil 21 is disposed and the layer in which the second coil 22 is disposed, an insulating portion 60 composed of an insulating material having lower magnetic permeability than that of the metal magnetic particles constituting the magnetic layers 11.

In plan view in the stacking direction (for example, the height direction T), the insulating portion 60 has a shape along the first coil 21. Therefore, in plan view in the stacking direction (for example, the height direction T), the first coil 21 overlaps with the insulating portion 60. On the other hand, the second coil 22 has a portion that does not overlap with the insulating portion 60 in plan view in the stacking direction (for example, the height direction T).

In plan view in the stacking direction (for example, the height direction T), the insulating portion 60 preferably has a square U shape having three sides.

Since the insulating portion 60 having lower magnetic permeability than that of the magnetic layers 11 is disposed between the first coil 21 and the second coil 22, the insulating properties of the element body 10 can be improved, and coupling between the first coil 21 and the second coil 22 can be increased.

As illustrated in FIG. 6, the insulating portion 60 preferably has a portion wider than the width of the first coil 21. In this case, the portion wider than the width of the first coil 21 may exist in the entire insulating portion 60 or may exist in part of the insulating portion 60. Moreover, the insulating portion 60 preferably has a portion longer than a leading end of the first coil 21. In this case, the insulating portion 60 may have a portion longer than the first end 30a of the first coil 21, may have a portion longer than the second end 30b of the first coil 21, or may have both the longer portions.

The insulating material constituting the insulating portion 60 is preferably composed of metal magnetic particles whose average particle diameter is smaller than that of the metal magnetic particles constituting the magnetic layers 11. In general, even when the composition of the metal magnetic particles is the same in the magnetic layers and the insulating portion, the metal magnetic particles having smaller average particle diameter have smaller magnetic permeability and can improve the insulating properties. Since metal magnetic particles having larger average particle diameter are disposed between cavities of the insulating portion 60, the inductance value of the second coil 22 becomes large, and the difference in inductance value between the first coil 21 and the second coil 22 can be made small.

The average particle diameter of the metal magnetic particles in the insulating portion 60 is preferably equal to or more than 0.2 μm and equal to or less than 5 μm (i.e., from 0.2 μm to 5 μm), more preferably equal to or more than 0.3 μm and equal to or less than 3 μm (i.e., from 0.3 μm to 3 μm), and still more preferably equal to or more than 0.5 um and equal to or less than 2 μm (i.e., from 0.5 μm to 2 μm).

Alternatively, the insulating material constituting the insulating portion 60 may be a non-magnetic material. In this case, the insulating material constituting the insulating portion 60 may be, for example, a resin material or may be a ceramic material.

The thickness of the insulating portion 60 may be larger than the thickness of the first conductor layer 51, may be smaller than the thickness of the first conductor layer 51, or may be the same as the thickness of the first conductor layer 51. Similarly, the thickness of the insulating portion 60 may be larger than the thickness of the second conductor layer 52, may be smaller than the thickness of the second conductor layer 52, or may be the same as the thickness of the second conductor layer 52.

The thickness of the insulating portion 60 is preferably equal to or more than 10 μm and equal to or less than 60 μm (i.e., from 10 μm to 60 μm), and more preferably equal to or more than 20 μm and equal to or less than 30 μm (i.e., from 20 μm to 30 μm).

Note that in the third embodiment of the present disclosure, the insulating portion may be disposed between the first coil and the second coil described in the first embodiment, or the insulating portion may be disposed between the first coil and the second coil described in the second embodiment.

### Fourth Embodiment

In a multilayer coil component according to a fourth embodiment of the present disclosure, a third coil and a fourth coil are further disposed inside the element body.

FIG. 7 is a perspective view schematically illustrating an example of an inside structure of the multilayer coil component according to the fourth embodiment of the present disclosure

[symbol]

In a multilayer coil component 4 illustrated in FIG. 7, the element body 10 includes the first coil 21, the second coil 22, the first outer electrode 31, the second outer electrode 32, the third outer electrode 33, the fourth outer electrode 34, the first via conductor 41, the second via conductor 42, the third via conductor 43, and the fourth via conductor 44. The multilayer coil component 4 further includes a third coil 23, a fourth coil 24, a fifth outer electrode 35, a sixth outer electrode 36, a seventh outer electrode 37, an eighth outer electrode 38, a fifth via conductor 45, a sixth via conductor 46, a seventh via conductor 47, and an eighth via conductor 48.

In the multilayer coil component 4, the first coil 21 and the second coil 22 constitute a first coil unit 71, and the third coil 23 and the fourth coil 24 constitute a second coil unit 72.

In the multilayer coil component 4, the first coil unit 71 and the second coil unit 72 face in the same direction and are arranged adjacently to each other. In the example illustrated in FIG. 7, the first coil unit 71 and the second coil unit 72 are arranged adjacently to each other in the length direction L.

In the multilayer coil component 4, since two coil units are arranged inside the element body 10, compared to a case where two multilayer coil components are separately arranged, the mounting area can be made small.

The third coil 23 includes the third conductor layer 53 and has a fifth end 30e and a sixth end 30f. The thickness of the third conductor layer 53 is preferably the same as the thickness of the first conductor layer 51.

The number of turns of the third coil 23 is preferably less than one. The third coil 23 preferably includes one conductor layer. The number of turns of the third coil 23 may be the same as or may be different from the number of turns of the first coil 21.

The fourth coil 24 is located further on the bottom surface side (the first main surface 10a side) of the element body 10 than is the second coil 22 in the stacking direction (for example, the height direction T) of the magnetic layers 11.

The fourth coil 24 includes the fourth conductor layer 54 and has a seventh end 30g and an eighth end 30h. The thickness of the fourth conductor layer 54 is preferably the same as the thickness of the third conductor layer 53. In addition, the thickness of the fourth conductor layer 54 is preferably the same as the thickness of the second conductor layer 52.

The number of turns of the fourth coil 24 is preferably less than one. The fourth coil 24 preferably includes one conductor layer. The number of turns of the fourth coil 24 may be the same as or may be different from the number of turns of the third coil 23. In addition, the number of turns of the fourth coil 24 may be the same as or may be different from the number of turns of the second coil 22.

In plan view in the stacking direction (for example, the height direction T), the third coil 23 preferably has a square U shape having three sides and more and preferably has the same shape as the first coil 21.

In plan view in the stacking direction (for example, the height direction T), the fourth coil 24 has a square U shape having three sides and two chamfered corner portions and more preferably has the same shape as the second coil 22.

Specifically, the fourth coil 24 preferably includes avoiding portions in corner portions. The avoiding portions of the fourth coil 24 are preferably disposed inside the fifth via conductor 45 and inside the sixth via conductor 46 in plan view in the stacking direction (for example, the height direction T) so as to avoid the fifth via conductor 45 and the sixth via conductor 46. The shape of each of the avoiding portions is not particularly limited, and may be linear or curved. In addition, the avoiding portion may be composed of two or more lines.

The fifth outer electrode 35 and the sixth outer electrode 36 are provided on the bottom surface (the first main surface 10a) of the element body 10 and are electrically coupled to the third coil 23. Specifically, the fifth outer electrode 35 is connected to the fifth end 30e of the third coil 23, and the sixth outer electrode 36 is connected to the sixth end 30f of the third coil 23.

The seventh outer electrode 37 and the eighth outer electrode 38 are provided on the bottom surface (the first main surface 10a) of the element body 10 and are electrically coupled to the fourth coil 24. Specifically, the seventh outer electrode 37 is connected to the seventh end 30g of the fourth coil 24, and the eighth outer electrode 38 is connected to the eighth end 30h of the fourth coil 24.

The fifth outer electrode 35 and the sixth outer electrode 36, and the seventh outer electrode 37 and the eighth outer electrode 38 are disposed at positions where fifth outer electrode 35 and the sixth outer electrode 36, and the seventh outer electrode 37 and the eighth outer electrode 38 face each other, respectively, and a straight line connecting the fifth outer electrode 35 to the seventh outer electrode 37 and a straight line connecting the sixth outer electrode 36 to the eighth outer electrode 38 preferably do not intersect with each other.

In the example illustrated in FIG. 7, the third outer electrode 33 and the fifth outer electrode 35 face each other, and the fourth outer electrode 34 and the sixth outer electrode 36 face each other.

The first outer electrode 31 may be provided only on the first main surface 10a of the element body 10, but the first outer electrode 31 may be disposed so as to extend over the first main surface 10a of the element body 10 and at least one of the first side surface 10c and the third side surface 10e.

The second outer electrode 32 may be provided only on the first main surface 10a of the element body 10, but the second outer electrode 32 may be disposed so as to extend over the first main surface 10a of the element body 10 and at least one of the second side surface 10d and the third side surface 10e.

The third outer electrode 33 may be provided only on the first main surface 10a of the element body 10, but the third outer electrode 33 may be disposed so as to extend over the first main surface 10a of the element body 10 and the first side surface 10c.

The fourth outer electrode 34 may be provided only on the first main surface 10a of the element body 10, but the fourth outer electrode 34 may be disposed so as to extend over the first main surface 10a of the element body 10 and the second side surface 10d.

The fifth outer electrode 35 may be provided only on the first main surface 10a of the element body 10, but the fifth outer electrode 35 may be disposed so as to extend over the first main surface 10a of the element body 10 and the first side surface 10c.

The sixth outer electrode 36 may be provided only on the first main surface 10a of the element body 10, but the sixth outer electrode 36 may be disposed so as to extend over the first main surface 10a of the element body 10 and the second side surface 10d.

The seventh outer electrode 37 may be provided only on the first main surface 10a of the element body 10, but the seventh outer electrode 37 may be disposed so as to extend over the first main surface 10a of the element body 10 and at least one of the first side surface 10c and the fourth side surface 10e.

The eighth outer electrode 38 may be provided only on the first main surface 10a of the element body 10, but the eighth outer electrode 38 may be disposed so as to extend over the first main surface 10a of the element body 10 and at least one of the second side surface 10d and the fourth side surface 10e.

Each of the first outer electrode 31, the second outer electrode 32, the third outer electrode 33, the fourth outer electrode 34, the fifth outer electrode 35, the sixth outer electrode 36, the seventh outer electrode 37, and the eighth outer electrode 38 may be composed of a conductive material such as Ag. For example, each of the first outer electrode 31, the second outer electrode 32, the third outer electrode 33, the fourth outer electrode 34, the fifth outer electrode 35, the sixth outer electrode 36, the seventh outer electrode 37, and the eighth outer electrode 38 includes a base electrode layer containing Ag and at least one plating layer provided above the base electrode layer. It is preferable that the plating layer includes a Cu plating layer provided above the base electrode layer, or includes an Ni plating layer provided above the base electrode layer and further includes an Sn plating layer provided above the Ni plating layer.

The thickness of each of the first outer electrode 31, the second outer electrode 32, the third outer electrode 33, the fourth outer electrode 34, the fifth outer electrode 35, the sixth outer electrode 36, the seventh outer electrode 37, and the eighth outer electrode 38 is preferably equal to or more than 5 μm and equal to or less than 100 μm (i.e., from 5 μm to 100 μm) and more preferably equal to or more than 10 μm and equal to or less than 50 μm (i.e., from 10 μm to 50 μm). The thicknesses of the first outer electrode 31, the second outer electrode 32, the third outer electrode 33, the fourth outer electrode 34, the fifth outer electrode 35, the sixth outer electrode 36, the seventh outer electrode 37, and the eighth outer electrode 38 are preferably the same.

The fifth via conductor 45, the sixth via conductor 46, the seventh via conductor 47, and the eighth via conductor 48 are provided inside the element body 10.

The fifth via conductor 45 connects the fifth end 30e of the third coil 23 and the fifth outer electrode 35. The fifth via conductor 45 preferably extends in the stacking direction (for example, the height direction T). The fifth via conductor 45 may have a stacked structure.

The sixth via conductor 46 connects the sixth end 30f of the third coil 23 and the sixth outer electrode 36. The sixth via conductor 46 preferably extends in the stacking direction (for example, the height direction T). The sixth via conductor 46 may have a stacked structure.

The seventh via conductor 47 connects the seventh end 30g of the fourth coil 24 and the seventh outer electrode 37. The seventh via conductor 47 preferably extends in the stacking direction (for example, the height direction T). The seventh via conductor 47 may have a stacked structure.

The eighth via conductor 48 connects the eighth end 30h of the fourth coil 24 and the eighth outer electrode 38. The eighth via conductor 48 preferably extends in the stacking direction (for example, the height direction T). The eighth via conductor 48 may have a stacked structure.

In the multilayer coil component 4, inside the element body 10, one pair of the first coil unit 71 and the second coil unit 72 may be disposed, or two or more pairs of the first coil unit 71 and the second coil unit 72 may be disposed.

### Fifth Embodiment

In a multilayer coil component according to a fifth embodiment of the present disclosure, the first coil unit and the second coil unit are plane-symmetrically disposed.

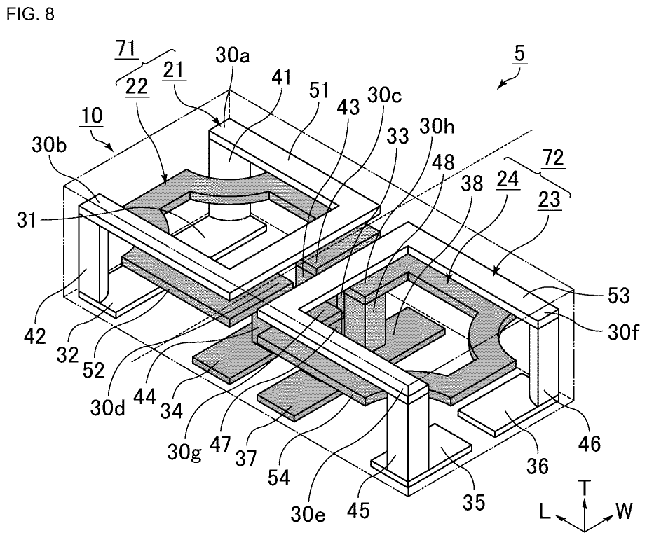

FIG. 8 is a perspective view schematically illustrating an example of an inside structure of the multilayer coil component according to the fifth embodiment of the present disclosure.

In a multilayer coil component 5 illustrated in FIG. 8, the first coil unit 71 and the second coil unit 72 are arranged adjacently to each other while facing opposite directions. Moreover, the first coil unit 71 and the second coil unit 72 are plane-symmetrically disposed.

In the example illustrated in FIG. 8, the third outer electrode 33 and the eighth outer electrode 38 face each other, and the fourth outer electrode 34 and the seventh outer electrode 37 face each other across a symmetric plane.

When the first coil unit 71 and the second coil unit 72 are plane-symmetrically disposed in the direction illustrated in FIG. 8, coupling between the first coil 21 and the second coil 22 and coupling between the third coil 23 and the fourth coil 24 can be increased.

Table 1 shows coupling coefficients between coils in the multilayer coil component 4 illustrated in FIG. 7 and the multilayer coil component 5 illustrated in FIG. 8. In Table 1, L1 represents the first coil 21, L2 represents the second coil 22, L3 represents the third coil 23, and L4 represents the fourth coil 24. Note that the coupling coefficients between the coils are calculated from the 3D magnetic field analysis results by the magnetic field analysis software Femtet (manufactured by Murata Software Co., Ltd.).

TABLE 1

| | Coupling Coefficient | | | |
|---|---|---|---|---|
| | L1-L2 | L3-L4 | L1-L3 | L2-L4 |
| Multilayer Coil | −0.288 | −0.297 | −0.001 | −0.011 |
| Component 4 (FIG. 7) | | | | |
| Multilayer Coil | −0.297 | −0.297 | −0.038 | 0.005 |
| Component 5 (FIG. 8) | | | | |

As shown in Table 1, in the multilayer coil component 5 in which the first coil unit 71 and the second coil unit 72 are plane-symmetrically disposed in the direction illustrated in FIG. 8, compared to the multilayer coil component 4 in which the first coil unit 71 and the second coil unit 72 are not plane-symmetrically disposed, absolute values of the coupling coefficients between L1-L2 and between L3-L4 are large, and coupling between the coils is high.

In the multilayer coil component 5, inside the element body 10, one pair of the first coil unit 71 and the second coil unit 72 may be disposed, or two or more pairs of the first coil unit 71 and the second coil unit 72 may be disposed. When two or more pairs of the first coil unit 71 and the second coil unit 72 are disposed inside the element body 10, it is sufficient as long as at least one pair of the first coil unit 71 and the second coil unit 72 is plane-symmetrically disposed, but it is preferable that all the pairs of the first coil unit 71 and the second coil unit 72 are plane-symmetrically disposed.

As described below, in the fourth embodiment and the fifth embodiment, the first coil unit and the second coil unit may be composed of the first coil and the second coil described in the first embodiment, or the first coil unit and the second coil unit may be composed of the first coil and the second coil described in the second embodiment. In this case, the first coil unit and the second coil unit may be composed of the first coil and the second coil of the same embodiment, or the first coil unit and the second coil unit may be composed of the first coil and the second coil of different embodiments. In addition, in at least one of the first coil unit and the second coil unit, an insulating portion may be disposed between the first coil and the second coil.

In the multilayer coil component 4 illustrated in FIG. 7 and the multilayer coil component 5 illustrated in FIG. 8, a distance between the seventh via conductor 47 and the eighth via conductor 48 may be shorter than a distance between the fifth via conductor 45 and the sixth via conductor 46.

The shape, vertical to the stacking direction, of each of the fifth via conductor 45, the sixth via conductor 46, the seventh via conductor 47, and the eighth via conductor 48 is not particularly limited, and examples of the shape include a polygonal shape such as a rectangle, a circle, an ellipse, and a fan shape.

Each of the fifth outer electrode 35, the sixth outer electrode 36, the seventh outer electrode 37, and the eighth outer electrode 38 preferably has an area, viewed in the stacking direction, larger than that of each of the fifth via conductor 45, the sixth via conductor 46, the seventh via conductor 47, and the eighth via conductor 48 so as to have the same shape.

Among the fifth via conductor 45, the sixth via conductor 46, the seventh via conductor 47, and the eighth via conductor 48, at least the seventh via conductor 47 and the eighth via conductor 48 are preferably not exposed on a side surface of the element body 10. On the other hand, the fifth via conductor 45 and the sixth via conductor 46 do not have to be exposed on a side surface of the element body 10 or may be exposed on at least one side surface of the element body 10.

In the multilayer coil component 4 illustrated in FIG. 7 and the multilayer coil component 5 illustrated in FIG. 8, the element body 10 may further include, between the layer in which the third coil 23 is disposed and the layer in which the fourth coil 24 is disposed, an insulating portion composed of an insulating material having lower magnetic permeability than that of the metal magnetic particles constituting the magnetic layers 11.

In plan view in the stacking direction (for example, the height direction T), the insulating portion has a shape along the third coil 23. Therefore, in plan view in the stacking direction (for example, the height direction T), the third coil 23 overlaps with the insulating portion. On the other hand, the fourth coil 24 has a portion that does not overlap with the insulating portion in plan view in the stacking direction (for example, the height direction T).

In plan view in the stacking direction (for example, the height direction T), the insulating portion preferably has a square U shape having three sides.

The insulating portion preferably has a portion wider than the width of the third coil 23. In this case, the portion wider than the width of the third coil 23 may exist in the entire insulating portion or may exist in part of the insulating portion. Moreover, the insulating portion preferably has a portion longer than a leading end of the third coil 23. In this case, the insulating portion may have a portion longer than the fifth end 30e of the third coil 23, may have a portion longer than the sixth end 30f of the third coil 23, or may have both the longer portions.

The insulating material constituting the insulating portion is preferably composed of metal magnetic particles whose average particle diameter is smaller than that of the metal magnetic particles constituting the magnetic layers 11.

The present specification discloses the following content.
1. A multilayer coil component comprising an element body including a plurality of stacked magnetic layers composed of metal magnetic particles; a first coil disposed inside the element body, including a first conductor layer, and having a first end and a second end; a second coil disposed inside the element body, including a second conductor layer, having a third end and a fourth end, and located further on a bottom surface side of the element body than is the first coil in a stacking direction of the magnetic layers; a first outer electrode provided on a bottom surface of the element body and connected to the first end of the first coil; a second outer electrode provided on the bottom surface of the element body and connected to the second end of the first coil; a third outer electrode provided on the bottom surface of the element body and connected to the third end of the second coil; and a fourth outer electrode provided on the bottom surface of the element body and connected to the fourth end of the second coil. The multilayer coil component further comprises a first via conductor provided inside the element body and connecting the first end of the first coil and the first outer electrode; a second via conductor provided inside the element body and connecting the second end of the first coil and the second outer electrode; a third via conductor provided inside the element body and connecting the third end of the second coil and the third outer electrode; and a fourth via conductor provided inside the element body and connecting the fourth end of the second coil and the fourth outer electrode.
2. The multilayer coil component according to 1, in which the number of turns of each of the first coil and the second coil is less than one.
3. The multilayer coil component according to 2, in which each of the first coil and the second coil includes one conductor layer.
4. The multilayer coil component according to any one of 1 to 3, in which the first outer electrode and the second outer electrode, and the third outer electrode and the fourth outer electrode are disposed at positions where the first outer electrode and the second outer electrode, and the third outer electrode and the fourth outer electrode face each other, respectively, and a straight line connecting the first outer electrode to the third outer electrode and a straight line connecting the second outer electrode to the fourth outer electrode do not intersect with each other.
5. The multilayer coil component according to 4, in which in plan view in the stacking direction, the first coil has a square U shape having three sides, and the second coil has a square U shape having three sides and two chamfered corner portions.
6. The multilayer coil component according to 4 or 5, in which a distance between the third via conductor and the fourth via conductor is shorter than a distance between the first via conductor and the second via conductor.
7. The multilayer coil component according to any one of 1 to 6, in which the element body further includes, between a layer in which the first coil is disposed and a layer in which the second coil is disposed, an insulating portion composed of an insulating material having lower magnetic permeability than magnetic permeability of the metal magnetic particles constituting the magnetic layers. Also, in plan view in the stacking direction, the insulating portion has a shape along the first coil.
8. The multilayer coil component according to 7, in which the insulating portion has a portion wider than a width of the first coil.
9. The multilayer coil component according to 7 or 8, in which the insulating material constituting the insulating portion is composed of metal magnetic particles whose average particle diameter is smaller than an average particle diameter of the metal magnetic particles constituting the magnetic layers.
10. The multilayer coil component according to any one of 1 to 9, in which among the first via conductor, the second via conductor, the third via conductor, and the fourth via conductor, at least the third via conductor and the fourth via conductor are not exposed on a side surface of the element body.
11. The multilayer coil component according to any one of 1 to 10, further comprising a third coil disposed inside the element body, including a third conductor layer, and having a fifth end and a sixth end; a fourth coil disposed inside the element body, including a fourth conductor layer, having a seventh end and an eighth end, and located further on the bottom surface side of the element body than is the third coil in the stacking direction; a fifth outer electrode provided on the bottom surface of the element body and connected to the fifth end of the third coil; a sixth outer electrode provided on the bottom surface of the element body and connected to the sixth end of the third coil; a seventh outer electrode provided on the bottom surface of the element body and connected to the seventh end of the fourth coil; an eighth outer electrode provided on the bottom surface of the element body and connected to the eighth end of the fourth coil. The multilayer coil component further comprises a fifth via conductor provided inside the element body and connecting the fifth end of the third coil and the fifth outer electrode; a sixth via conductor provided inside the element body and connecting the sixth end of the third coil and the sixth outer electrode; a seventh via conductor provided inside the element body and connecting the seventh end of the fourth coil and the seventh outer electrode; and an eighth via conductor provided inside the element body and connecting the eighth end of the fourth coil and the eighth outer electrode. The first coil and the second coil constitute a first coil unit, the third coil and the fourth coil constitute a second coil unit, and the first coil unit and the second coil unit are arranged adjacently to each other.
12. The multilayer coil component according to 11, in which the first coil unit and the second coil unit are plane-symmetrically disposed.
13. The multilayer coil component according to 12, in which the third outer electrode and the eighth outer electrode face each other, and the fourth outer electrode and the seventh outer electrode face each other across a symmetric plane.

What is claimed is:

1. A multilayer coil component comprising:
an element body including a plurality of stacked magnetic layers including metal magnetic particles;
a first coil inside the element body, including a first conductor layer, and having a first end and a second end;
a second coil inside the element body, including a second conductor layer, having a third end and a fourth end, and located further on a bottom surface side of the element body than is the first coil in a stacking direction of the magnetic layers;
a first outer electrode on a bottom surface of the element body and connected to the first end of the first coil;
a second outer electrode on the bottom surface of the element body and connected to the second end of the first coil;
a third outer electrode on the bottom surface of the element body and connected to the third end of the second coil;
a fourth outer electrode on the bottom surface of the element body and connected to the fourth end of the second coil;
a first via conductor inside the element body and connecting the first end of the first coil and the first outer electrode;
a second via conductor inside the element body and connecting the second end of the first coil and the second outer electrode;
a third via conductor inside the element body and connecting the third end of the second coil and the third outer electrode; and
a fourth via conductor inside the element body and connecting the fourth end of the second coil and the fourth outer electrode.

2. The multilayer coil component according to claim 1, wherein
a number of turns of each of the first coil and the second coil is less than one.

3. The multilayer coil component according to claim 2, wherein
each of the first coil and the second coil includes one conductor layer.

4. The multilayer coil component according to claim 1, wherein
the first outer electrode and the second outer electrode, and the third outer electrode and the fourth outer electrode, are at positions where the first outer electrode and the second outer electrode, and the third outer electrode and the fourth outer electrode face each other, respectively, and a straight line connecting the first outer electrode to the third outer electrode and a straight line connecting the second outer electrode to the fourth outer electrode do not intersect with each other.

5. The multilayer coil component according to claim 4, wherein
in plan view in the stacking direction, the first coil has a square U shape having three sides, and the second coil has a square U shape having three sides and two chamfered corner portions.

6. The multilayer coil component according to claim 4, wherein
a distance between the third via conductor and the fourth via conductor is shorter than a distance between the first via conductor and the second via conductor.

7. The multilayer coil component according to claim 1, wherein
the element body further includes, between a layer in which the first coil is disposed and a layer in which the second coil is disposed, an insulating portion comprising an insulating material having lower magnetic permeability than magnetic permeability of the metal magnetic particles of the magnetic layers, and
in plan view in the stacking direction, the insulating portion has a shape along the first coil.

8. The multilayer coil component according to claim 7, wherein
the insulating portion has a portion wider than a width of the first coil.

9. The multilayer coil component according to claim 7, wherein
the insulating material of the insulating portion includes metal magnetic particles whose average particle diameter is smaller than an average particle diameter of the metal magnetic particles of the magnetic layers.

10. The multilayer coil component according to claim 1, wherein
among the first via conductor, the second via conductor, the third via conductor, and the fourth via conductor, at least the third via conductor and the fourth via conductor are not exposed on a side surface of the element body.

11. The multilayer coil component according to claim 1, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

12. The multilayer coil component according to claim 11, wherein
the first coil unit and the second coil unit are plane-symmetrically disposed.

13. The multilayer coil component according to claim 12, wherein
the third outer electrode and the eighth outer electrode face each other, and the fourth outer electrode and the seventh outer electrode face each other across a symmetric plane.

14. The multilayer coil component according to claim 2, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

15. The multilayer coil component according to claim 3, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

16. The multilayer coil component according to claim 4, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

17. The multilayer coil component according to claim 5, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

18. The multilayer coil component according to claim 6, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

19. The multilayer coil component according to claim 7, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.

20. The multilayer coil component according to claim 8, further comprising:
a third coil inside the element body, including a third conductor layer, and having a fifth end and a sixth end;
a fourth coil inside the element body, including a fourth conductor layer, having a seventh end and an eighth end, and located further on the bottom surface side of the element body than is the third coil in the stacking direction;
a fifth outer electrode on the bottom surface of the element body and connected to the fifth end of the third coil;
a sixth outer electrode on the bottom surface of the element body and connected to the sixth end of the third coil;
a seventh outer electrode on the bottom surface of the element body and connected to the seventh end of the fourth coil;
an eighth outer electrode on the bottom surface of the element body and connected to the eighth end of the fourth coil;
a fifth via conductor inside the element body and connecting the fifth end of the third coil and the fifth outer electrode;
a sixth via conductor inside the element body and connecting the sixth end of the third coil and the sixth outer electrode;
a seventh via conductor inside the element body and connecting the seventh end of the fourth coil and the seventh outer electrode; and
an eighth via conductor inside the element body and connecting the eighth end of the fourth coil and the eighth outer electrode, wherein
the first coil and the second coil configure a first coil unit,
the third coil and the fourth coil configure a second coil unit, and
the first coil unit and the second coil unit are adjacent to each other.
